(19) United States
(12) Patent Application Publication
(10) Pub. No.: US 2025/0172649 A1
(43) Pub. Date: May 29, 2025

(54) ELECTROMAGNETIC PULSE (EMP) DETECTOR AND SYSTEM

(71) Applicant: LUDLUM MEASUREMENTS, INC., Sweetwater, TX (US)

(72) Inventors: Kevin R. Marriott, Herriman, UT (US); Wyatt M. Felt, Millcreek, UT (US); Bryce H. Lembke, South Jordan, UT (US)

(21) Appl. No.: 18/961,200

(22) Filed: Nov. 26, 2024

Related U.S. Application Data
(60) Provisional application No. 63/603,497, filed on Nov. 28, 2023.

(51) Int. Cl. G01S 3/12; G01S 3/36; H01Q 7/00; H01Q 21/24

(52) U.S. Cl. CPC G01S 3/12; G01S 3/36; H01Q 7/00; H01Q 21/24

(57) ABSTRACT

A EMP detection system may include a dual-loop antenna, including: an antenna substrate having a first side and a second side opposite the first side, a first loop antenna located on the first side, the first loop antenna having a first polarity; and a second loop antenna located on the second side, the second loop antenna having a second polarity opposite the first polarity.

### CROSS REFERENCE TO RELATED APPLICATIONS

This claims priority to U.S. Provisional Patent Application Ser. No. 63/603,497, filed on Nov. 28, 2023, and entitled “ELECTROMAGNETIC PULSE (EMP) DETECTOR AND SYSTEM,” which is hereby incorporated herein by reference in its entirety.

### BACKGROUND

Recent years have seen significant improvements in the detection of electromagnetic signals and electromagnetic pulses (EMPs). EMPs may include a spike in electromagnetic radiation, including spikes in electric and magnetic fields in an area. Such spikes in electromagnetic radiation may originate from multiple different sources. For example, EMPs may originate from natural sources, such as lightning, meteoric, coronal mass ejection (CME), electrostatic discharge (ESD), any other natural source of EMP, and combinations thereof. In some examples, EMPs may originate from artificial or man-made sources, such as electromagnetic communications, electric motors, power surges on the power grid (e.g., power lines, power generation systems, transformers), activation of electronic switches, nuclear electromagnetic pulse (NEMP), any other artificial EMP, and combinations thereof.

The fluctuating electric and magnetic fields of an EMP may induce an electric current in the electronic components of electronic circuits. In some situations, this may cause circuitry to be “overloaded” or to have a greater amount of current pass through the electronic components than they can safely process, which may result in temporary and/or permanent damage to the electronic components. Such circuit overload may be prevalent in the largest EMPs, or the EMPs that have the highest spike in electromagnetic radiation. In some situations, an EMP may be a result of a weapon and/or intentionally weaponized, such as a nuclear weapon and/or a weaponized EMP generator. Such weaponized EMPs may result in general damage to electronic circuitry and/or electric infrastructure, including large-scale (e.g., city, region, state, national, or global scale) damage to electronic circuitry and/or electric infrastructure.

Electric circuitry may be protected from EMPs in various ways. For example, electric circuitry may be shielded from an EMP. Examples of such shielding may include wire mesh structures such as a Faraday cage. In some examples, unpowered electric circuitry may not be as heavily impacted by an EMP event. Because it may be difficult, expensive, and/or impractical to shield all electronic components in an area, it is often desirable to power down electronic circuitry for the duration of an EMP event.

EMP events are often unpredictable, including weaponized EMP events. It may be impractical to maintain electronic equipment in a powered down mode. In some situations, EMP protection systems include detection systems that may detect an EMP event and provide warning in sufficient time for sensitive and/or unshielded electronic circuitry to be powered down. Conventional detection systems can include antennas that monitor spikes in the electromagnetic flux at the antenna. Typically, these antennas are continuously monitored with a monitoring system that includes many powered circuits. But such circuits may be sensitive to damage by an EMP, and by their nature may be difficult to shield because of their exposure to the EMP during detection. Further, such circuits may only be operable when connected to a power source.

### BRIEF DESCRIPTION OF THE DRAWINGS

The detailed description provides one or more embodiments with additional specificity and detail through the use of the accompanying drawings, as briefly described below.

FIG. 1 is a schematic representation of an EMP system, according to at least one embodiment of the present disclosure.

FIG. 2 is a perspective-view of a representation of an EMP detection system, according to at least one embodiment of the present disclosure.

FIG. 3 is a top-down representation of a dual-loop antenna, according to at least one embodiment of the present disclosure.

FIG. 4 is a representation of an EMP detection system, according to at least one embodiment of the present disclosure.

FIG. 5 is a representation of an EMP detection system, according to at least one embodiment of the present disclosure.

FIG. 6 is a representation of an EMP detection system, according to at least one embodiment of the present disclosure.

FIG. 7 is a flowchart of a control system for an EMP detection system, according to at least one embodiment of the present disclosure.

FIG. 8 is a flowchart of an example series of acts for performing EMP detection in accordance with one or more embodiments.

FIG. 9 is a flowchart of another example series of acts for performing EMP detection in accordance with one or more embodiments.

FIG. 10 is a representation of a computing system, according to at least one embodiment of the present disclosure.

### DETAILED DESCRIPTION

The present disclosure relates to devices, systems, and methods for detecting one or more EMP events using a low-power EMP detection system. The EMP detection system utilizes one or more dual-loop antennas. The dual-loop antenna(s) includes two wire loop antennas secured to either side of a substrate. Each wire loop antenna is connected to multiple event discrimination filter inputs. Each event discrimination filter consists of one or more diode rectifiers, one or more resistors, and one or more capacitors. When an EMP event occurs, the electromagnetic flux from the EMP event may cause a current to be applied to the wire loop antenna. The current may be transferred through the output of the wire loop antenna to one or more event discrimination filters. The event discrimination filters may be used to distinguish between different types and/or different magnitudes of EMP events. If an EMP event exceeds a trigger threshold, then the EMP detection system may generate an alert. In this manner, the EMP detection system may help to provide early detection and quantification of EMP events.

The two wire loop antennas that make up each of the one or more dual-loop antennas are wound in opposite directions (counter clockwise and clockwise) with respect to a common feed point so that the instantaneous voltage generated at the output of each wire loop antenna when responding to a change in intensity of the magnetic field is of opposite polarity to the instantaneous voltage generated for that same change in intensity of the magnetic field at the output of the other loop antenna within the same dual-loop antenna. This creates the ability to separately measure the different polarities of the antenna voltage responses, which correspond to the rising and falling magnitudes of an EMP magnetic field. This, together with the analog signal filtering, storage, and unipolar signal rectification supports further discrimination of nuclear-source EMP events from other non-nuclear-source EMP-like events.

In accordance with at least one embodiment of the present disclosure, the EMP detection system may detect EMP events while in a low-power mode, and then enter an analysis and transmission mode when the EMP detection system detects an EMP event that exceeds a trigger threshold. For example, the EMP detection system may, in a low-power mode, passively collect electromagnetic measurements using the dual-loop antennas. The electromagnetic measurements may be filtered by the one or more event discrimination filters. When the output of the one or more event discrimination filters exceeds the trigger threshold, a trigger system may cause the EMP detection system to enter into an analysis and transmission mode. Where the EMP event is less than the trigger threshold, the EMP system may maintain the low-power mode. The analysis and transmission mode may be classified as a high-power mode (e.g., a higher power mode than a low power mode). When operating in the analysis and transmission mode, the EMP detection system may provide further analysis of the EMP event, transmit an alert to an operator, implement emergency shut-down procedures, perform any other action, and combinations thereof. Monitoring EMP events in the low-power mode (also discussed herein as passively monitoring) may help to reduce the total power consumption of the EMP detection system. In some embodiments, passively monitoring for EMP events may allow the EMP detection system to monitor for EMP events for extended periods of time on relatively small power sources. In accordance with at least one embodiment of the present disclosure, a single D-cell lithium thionyl chloride or Li-SoCl2 battery may power the EMP detection system for 10 years or more.

When the EMP voltage exceeds the trigger threshold and the EMP detection system enters the analysis and transmission mode, the EMP detection system may analyze the voltage from the EMP event after the EMP event has occurred. For example, the EMP event may charge one or more capacitors. The rise, peak, and fall of the capacitor charge may be recorded. Entering the analysis and transmission mode may take a power-up time period. The power-up time period may cause the EMP detection system to be powered up after the peak of the EMP event has passed. This may help to reduce damage to the EMP detection system and/or reduce the amount of shielding used to protect the circuitry of the EMP detection system. To identify the type, magnitude, direction, and other elements of the EMP event, the EMP detection system may analyze the voltage on the capacitor, including the maximum voltage and/or the rate of change of the voltage. This post-hoc review of the voltage of the EMP event may facilitate the EMP detection system's low-power monitoring and/or reduce damage to the EMP detection system from the EMP detection itself.

In some embodiments one or more instances of the EMP detection system may be arranged spatially to help mitigate the potential for false alarms, to increase the confidence that a given alarm came from an event impacting a large area, and/or to triangulate the source of the EMP causing the alarms. In some embodiments, a single EMP detection system may be placed in an isolated area where it is unlikely to experience significant fields from commonplace electrostatic discharge events. Examples of possible isolated areas include a tripod with a keep-out area surrounding it, an elevated position on a mast/pole, or on the corner of a building.

In some embodiments, multiple instances of the EMP detection system may communicate with each other or an outside information aggregator to add confidence to the large-scale of an event. For example, multiple units can be spaced several meters to tens of meters apart and, after a potential EMP-like event, communicate (e.g., wirelessly or through a fiber-optic connection) to confirm that each device experienced field-levels that would be expected for an event with potentially broad impacts. If only one of the units detected the EMP, then it is likely that the detected EMP was caused by a spurious, local event such as a commonplace electrostatic discharge. However, if both units detect an EMP-like event of similar apparent magnitude, then it is more likely that the detected EMP was caused by a large, distant event.

Furthermore, in another embodiment, multiple instances of the EMP detection system can be spaced tens or hundreds of miles apart. In such an embodiment, after an EMP event, the measured field magnitudes and field orientations from the multiple units can be aggregated and analyzed at a central location to triangulate the source of the EMP event. This communication can be accomplished with, for example, individual satellite modems on each unit that, after an EMP event, are electrically engaged using a relay with an antenna outside of the shielding enclosure. In such an embodiment, each detection unit can estimate a vector pointing towards the source of a potential nuclear EMP. Data from multiple units can be analyzed together to develop estimates and confidence levels of the location and energy of the EMP source.

As illustrated by the foregoing discussion, the present disclosure utilizes a variety of terms to describe features and advantages of the EMP detection system. Additional detail is now provided regarding the meaning of such terms. For example, as used herein, the term electromagnetic pulse (EMP) refers to a sudden increase or spike in electromagnetism. The increase in electromagnetism may include any form of electromagnetism, such as an increase in the local magnetic field, an increase in the local electric field, an increase in electromagnetic radiation, any other increase in electromagnetism, and combinations thereof including or excluding any of the foregoing. EMPs may have various different waveforms and/or wavelengths. An EMP may originate from multiple sources, including natural sources (such as lightning) and artificial sources (such as nuclear detonations and/or an EMP generator). An EMP that originates above the ground in the atmosphere may be a high-altitude EMP (HEMP). The sudden increase of the field strength may be from a nominal level to a peak level in a time period that is less than a nanosecond, on the order of two nanoseconds (as with a nuclear HEMP “E1” pulse), or on the order of one microsecond (as can be the case with natural lightning). The EMP may also be a brief burst of sinusoidal field oscillations from, for example, a high-powered RADAR system or from an electromagnetic weapon. In one or more implementations described herein, an EMP event may refer to any occurrence or event that causes or results in a sudden increase or spike in electromagnetism above some predetermined threshold.

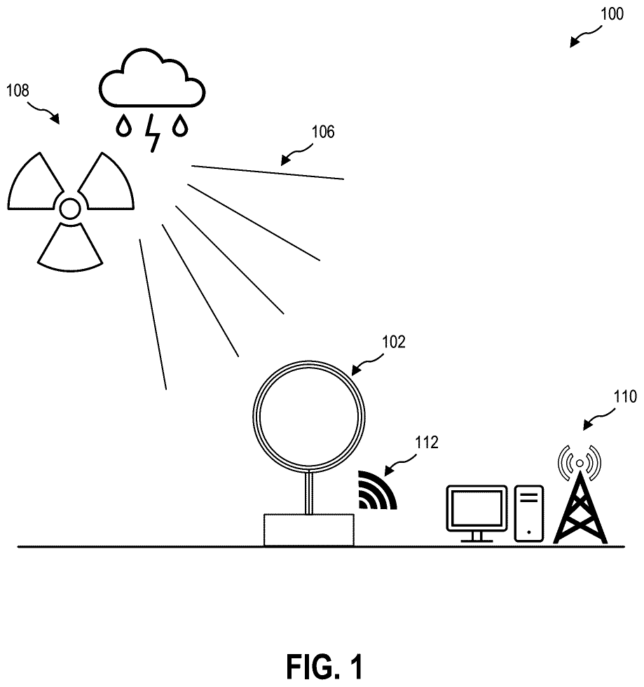

FIG. 1 is a schematic environmental representation of an EMP system 100, according to at least one embodiment of the present disclosure. The EMP system 100 may include an EMP detection system 102. The EMP detection system 102 may include a plurality of dual-loop antennas 104 (e.g., a multi-dual-loop antenna system). In some situations, an EMP event 106 may originate from an EMP source 108. The EMP event 106 may be harmful to powered electronics 110, such as computing devices, communication devices, the power grid, any other powered electronic, and combinations thereof. When the EMP event 106 occurs, the electromagnetism of the EMP event 106 may induce a current in the plurality of dual-loop antennas 104 of the EMP detection system 102. Based on the current in the plurality of dual-loop antennas 104, the EMP detection system 102 may identify the occurrence of the EMP event 106. The EMP event 106 may provide one or more alerts 112, warnings, power-down, or other instructions to the powered electronics 110 or human operators. This may allow the powered electronics 110 to implement mitigating procedures, such as powering down, entering shielding, or mitigating procedure. This may help to reduce the impact of the EMP event 106 on the powered electronics 110. The EMP detection system 102 may alert, through, for example, an auditory alarm and/or visual alert 112 to nearby human operators or other systems of the possibility of damage or disruption to electrical systems both near the detection system 102 and closer to the EMP event 106.

As may be understood, different EMP sources 108 may have different impacts on the powered electronics 110. For example, EMP events 106 resulting from lightning may not have a severity and/or intensity that is sufficient to damage the powered electronics 110. Indeed, it is common for large powered electrical systems 110 to be protected using one or more lightning rods, or a conductive rod that may attract the lightning and transfer the current from the lightning to a ground. Other EMP sources 108 may be harmful to the powered electronics 110. For example, EMP events 106 that originate from a nuclear detonation and/or an artificial EMP generator may have properties that are damaging to the powered electronics 110. Metallic shielding or protection circuitry may help to reduce damage to the powered electronics 110, but such measures can be expensive and/or impractical to implement in all situations.

In accordance with at least one embodiment of the present disclosure, the EMP detection system 102 may identify EMP events 106 that may be harmful to the powered electronics 110. In some embodiments, the EMP detection system 102 may identify an EMP event 106 and provide an alert 112 to the powered electronics 110. For example, the plurality of dual-loop antennas 104 may direct the currents induced by the EMP event 106 to one or more discrimination circuits. The discrimination circuits may analyze the properties of the EMP event 106, including the voltage profile of the EMP event 106. If the voltage profile of the EMP event 106 matches a trigger profile, then the EMP detection system 102 may identify that the EMP event 106 has occurred and provide the alert 112 to the powered electronics 110.

In some embodiments, the EMP detection system 102 may be powered with an independent power source such as a battery. The EMP detection system 102 may monitor for the EMP event 106 in a low-power mode. In the low-power mode, the EMP detection system 102 may monitor the voltage profile measured by the plurality of dual-loop antennas 104. If the voltage profile matches a trigger, then the EMP detection system 102 may enter a higher-power analysis and transmission mode. In the analysis and transmission mode, the EMP detection system 102 may review the voltage profile of the EMP event 106 in greater detail and determine whether to transmit an alert 112 and which information to include in the alert 112. The alert can include information about the estimated intensity of the pulse and the time at which it occurred. A visual component of the alert 112 may be displayed outside of the shielded enclosure using light pipes that allow the electronics to be relatively distant from the wall of the enclosure.

In accordance with at least one embodiment of the present disclosure, the EMP detection system 102 may be able to identify details surrounding the EMP source 108, the magnitude of the local EMP event 106 (e.g., in V/m), the direction of the source of the EMP event 106, the distance of the source of the EMP event 106, the elevation of the source of the EMP event 106, any other information regarding the EMP event 106, and combinations thereof. Using multiple spatially separated units, the location of the source of the EMP event 106 can be estimated through triangulation. For example, each dual-loop antenna of the dual-loop antennas 104 may independently identify the EMP event 106. Each antenna from the dual-loop antennas 104 may receive a different voltage profile, based on the differences in orientation of the dual-loop antennas 104. Based on the differences in the voltage profile for each of the dual-loop antennas 104, the EMP detection system 102 may identify details surrounding the EMP event 106, including a relative vector pointing from the EMP detection system 102 towards the EMP event 106. If the locations of multiple EMP units 102 are known, the vectors from each unit pointing towards the source of the EMP can be calculated and combined to estimate the location of the EMP event. The confidence of the location estimate can also be calculated.

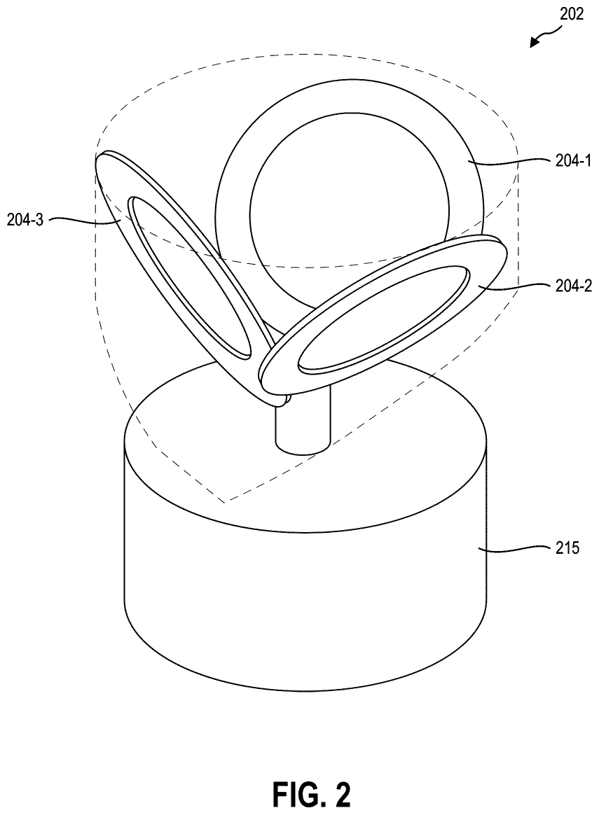

FIG. 2 is a perspective-view of a representation of an EMP detection system 202, according to at least one embodiment of the present disclosure. It will be noted that this depiction of the EMP detection system 202 may not be to scale, but is provided for illustrative purposes to show example features and characteristics of the EMP detection system 202. As shown in FIG. 2, the EMP detection system 202 includes a plurality of dual-loop antennas (collectively 204). For example, the EMP detection system 202 shown includes three dual-loop antennas 204, including a first dual-loop antenna 204-1, a second dual-loop antenna 204-2, and a third dual-loop antenna 204-3. The dual-loop antennas 204 may be arranged mutually orthogonal to each other. For example, the first dual-loop antenna 204-1 may be arranged orthogonal or perpendicular to the second dual-loop antenna 204-2 and the third dual-loop antenna 204-3, the second dual-loop antenna 204-2 may be arranged orthogonal or perpendicular to the first dual-loop antenna 204-1 and the third dual-loop antenna 204-3, and the third dual-loop antenna 204-3 may be arranged orthogonal or perpendicular to the first dual-loop antenna 204-1 and the second dual-loop antenna 204-2. Arranging the dual-loop antennas 204 orthogonal to each other may improve the sensitivity of the EMP detection system 202. For example, orthogonal dual-loop antennas 204 may facilitate the identification of the direction and/or magnitude of the EMP event based on the difference in the signal between the dual-loop antennas 204.

The dual-loop antennas 204 may be secured to a processing base 215. The processing base 215 may include one or more circuits that may process the signals induced on the dual-loop antennas 204. For example, the processing base 215 may include an event-discrimination circuit, a trigger-detection circuit, a power-up circuit, operational amplifiers, diodes, capacitors, relays, dividers, any other electronic circuit, and combinations thereof. The processing base 215 may include a shielding enclosure structure from an electrically conductive metal or alloy (e.g., aluminum) to protect the internal electronic circuitry from the negative effects of an EMP. The shielding enclosure structure may have apertures to allow light, sound or wires to reach the outside of the enclosure but such apertures are small to prevent significant ingress of the potentially harmful electromagnetic radiation associated with an EMP.

In some embodiments, the processing base 215 may include an independent power source. For example, the processing base 215 may include a battery. The battery may power the EMP detection system 202. As discussed herein, the power source may power the EMP detection system 202 to passively detect EMP events. For example, during passive detection of EMP events, the dual-loop antennas 204 may be unpowered, and the only powered circuits may be the event discrimination circuit and the trigger detection circuit. These circuits may be ultra-low power and may consume on the order of 50 μA of power in the low-power mode.

The independent power source may facilitate independent operation of the EMP detection system 202. For example, conventional EMP detectors actively monitor for EMP events, and consume significant amounts of power. While batteries or other independent power sources may be used to power such systems, these power sources may not power the conventional EMP detector for any extended period of time without a large, heavy, and/or expensive power system which may make practical application of the detector infeasible. This may limit the independent operation of such EMP detectors, particularly in locations without ready access to power sources.

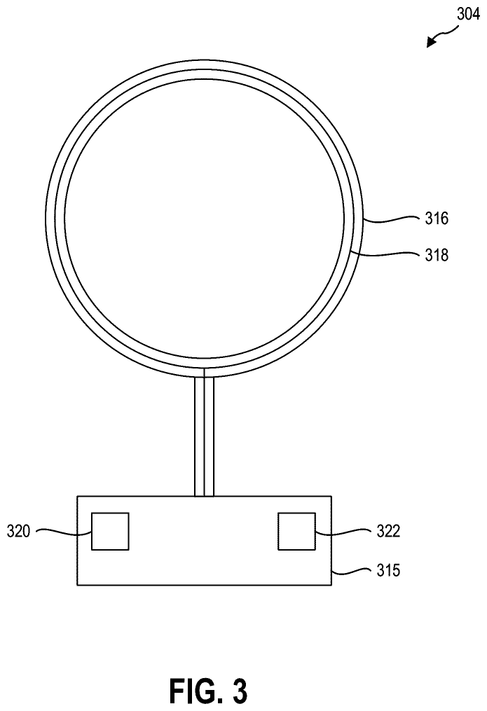

FIG. 3 is a top-down representation of a dual-loop antenna 304, according to at least one embodiment of the present disclosure. The dual-loop antenna 304 includes an antenna substrate 316. A loop antenna 318 may be secured to either side of the antenna substrate 316. For example, the antenna substrate 316 may include a first side, and a first loop antenna 318 may be secured to the first side of the antenna substrate 316. The antenna substrate 316 may include a second side, opposite the first side (not shown in FIG. 3), and a second loop antenna may be secured to the second side.

In accordance with at least one embodiment of the present disclosure, the dual loop antenna may utilize a single polarity of rectifier diode(s) rather than an at-least-four-diode element bridge on each antenna output. A single diode rectifier incurs approximately half the voltage drop of a bridge rectifier. The bridge rectifier presents significant capacitive loading of the loop antenna output signal compared to the capacitive loading of single diode rectifier. This may help to improve the sensitivity of the dual-loop antenna 304 relative to other antenna configurations.

The upper loop antenna 318 is coupled to its filter loads through diodes oriented in one polarity. The bottom loop antenna 318 is coupled to its filter loads through diodes oriented in the opposite polarity. The upper loop antenna 318 will respond maximally when the plane in which it lies is perpendicular to a magnetic field that is increasing. The bottom loop antenna 318 will respond maximally when the plane in which it lies is perpendicular to a magnetic field that is decreasing. To the extent that either of the dual antennas is open circuit (not loaded), it will minimally impact the current and voltage seen by a load connected to the other antenna if capacitive coupling is minimized. This may be achieved by providing spacing between the two loops that reduces capacitive coupling to less than a picofarad. The not loaded loop antenna may further reduce the impact of the other antenna by reducing the arcing potential caused by the voltage differential between the loaded and unloaded antenna loops.

The dual-loop antenna system may help to facilitate discrimination between the positive and negative polarity changes in magnetic flux associated with certain EMP events, thereby allowing for the distinction between different types of EMP events. The dual-loop antenna system may further reduce the forward voltage drop of the signal rectification stage by using single polarity rectification rather than bipolarity rectification required for a single loop antenna. The dual-loop antenna system may further reduce parasitic capacitance when compared to the full bridge rectifier that would be used with a single loop antenna yielding a non-negative voltage signal output. The voltage polarity of signals resulting from both the positive and negative polarity changes in magnetic flux are positive with respect to a common ground rather than positive and negative with respect to a common ground that would be seen with other non-bridge rectifier implementations, thereby improving the detection capacity of the dual-loop antennas. The independent measurement of the two voltage polarities allows the system to discriminate between EMP events that are pulse-like (e.g., a rapid rise time to a peak field strength followed by a slower decay) and those that are more like a burst of a continuous-wave-like signal (e.g., sinusoidal field values). This allows the system to differentiate between pulses originating from a high-altitude nuclear detonation (HEMP) and those from a RADAR or oscillating-field electromagnetic weapon.

The loop antennas 318 may be connected to a processing base 315. The processing base 315 may include one or more circuits that may process the signal received from the loop antennas 318, as discussed in further detail herein.

Each of the loop antennas 318 may be connected to independent analog front-end circuitry 320. The front-end circuitry 320 may passively receive and process the signal from the loop antennas 318. For example, the front-end circuitry 320 may detect and store the characteristics of the early time-phase, high-frequency portion of an EMP event. In some embodiments, the front-end circuitry 320 may distinguish the energy associated with the rise of the HEMP transient from the energy associated with the fall of the HEMP transient. As discussed herein, the loop antennas 318 and the front-end circuitry 320 may be passive. Put another way, the loop antennas 318 and the front-end circuitry 320 may be unpowered and/or monitor for EMP events without receiving power from the independent power source.

The front-end circuitry 320 may include diodes that feed into one or more capacitors to store the energy from the EMP event for later analysis. For example, the capacitors may be charged during passive collection of EMP event measurements. After the microcontroller is powered up, the charge on the capacitors may be analyzed.

The front-end circuitry 320 may include an electronic switch that can be triggered when a capacitor level exceeds a certain threshold. For example, when a particular triggering capacitor exceeds a voltage threshold, the switch may cause a microcontroller 322 to enter the analysis and transmission mode. The voltage threshold may be associated with a potentially damaging or disruptive EMP event. When the system powers up, the microcontroller 322 may record the voltage on the capacitors charged by the loop antennas 318. Because the capacitors may retain the charge for the period of time the microcontroller 322 takes to wake up, when the microcontroller 322 is powered up, the capacitors may still be powered, thereby allowing for a more detailed analysis of the charge. This may allow the microcontroller 322 to determine the type of the EMP event, identify the intensity of the EMP event, and determine whether to record the event and/or generate an alarm related to the EMP event. When the voltage is less than the voltage threshold, then the EMP system may maintain the system in the low-power mode.

As discussed herein, using the relative intensities of the signals detected by the dual-loop antenna 304, including other connected dual-loop antennas (such as dual-loop antennas connected orthogonally or at other orientations), the microcontroller 322 may estimate a spatial vector corresponding to the orientation of the electric field associated with the EMP event relative to the body of the detector. Based on a known orientation and location of the detector at the time of the event are known, this relative spatial vector can be transformed into an absolute spatial vector described by, for example, azimuth and elevation, which points to the source of the EMP event. The spatial vectors and recorded intensities estimated by multiple detector units can be combined to estimate the explosive yield and triangulate an estimated location for a nuclear detonation that resulted in the EMP event.

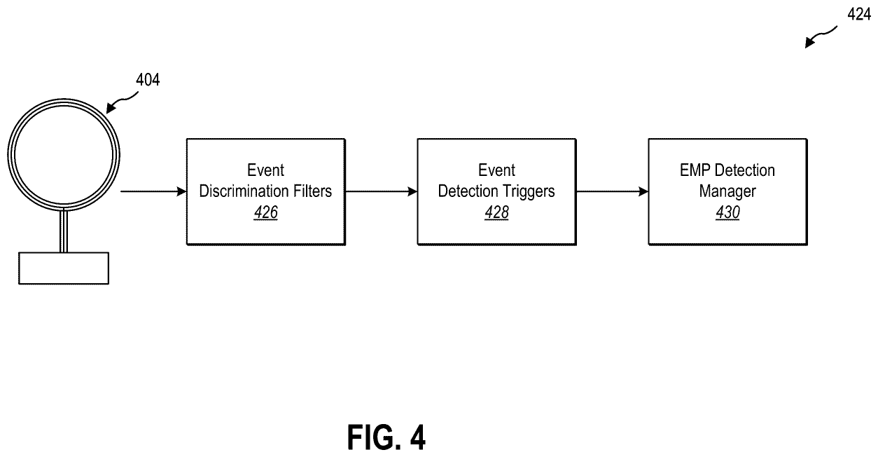

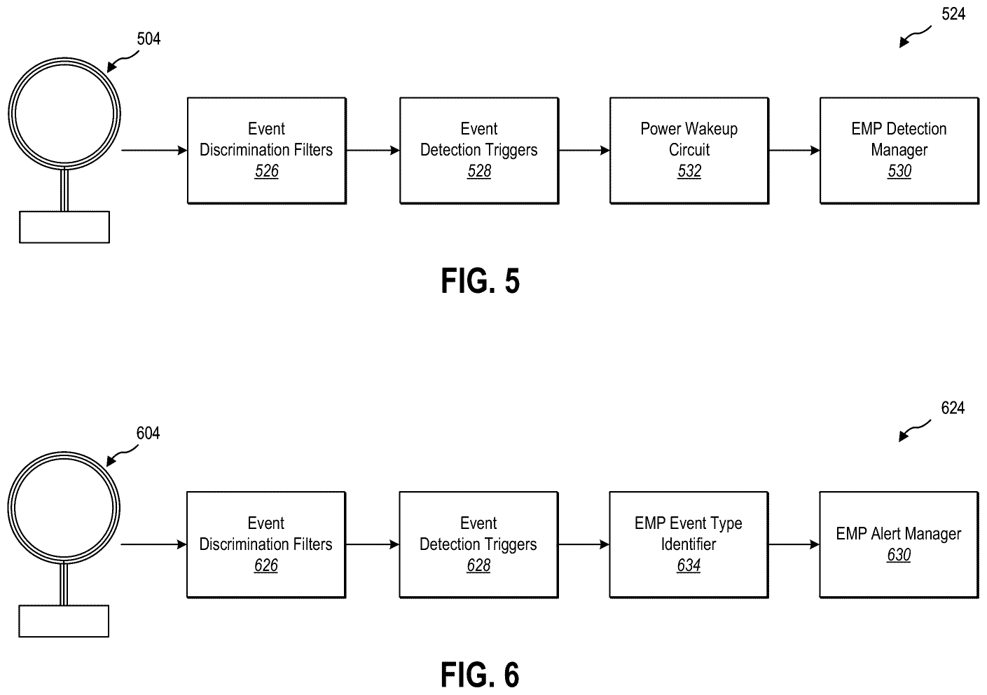

FIG. 4 is an example representation of an EMP detection system 424, according to at least one embodiment of the present disclosure. Each of the components of the EMP detection system 424 (and similarly, the EMP detection system 524 and the EMP detection system 624 discussed below in connection with FIGS. 5 and 6) can be implemented using software, hardware, or a combination of both. For example, the components can include one or more instructions stored on a computer-readable storage medium and executable by processors of one or more computing devices, such as a client device or server device. When executed by the one or more processors, the computer-executable instructions of the EMP detection systems discussed herein can cause the computing device(s) to perform the methods described herein. Alternatively, the components can include hardware, such as a special-purpose processing device to perform a certain function or group of functions. Alternatively, the components of the EMP detection system can include a combination of computer-executable instructions and hardware.

In the EMP detection system 424, a dual-loop antenna 404 may sense electromagnetism, such as through current induced in the antennas of the dual-loop antenna 404. One or more event discrimination filters 426 may receive the sensed signal. The event discrimination filters 426 may filter the incoming signal and transmit the filtered signal (e.g., the filtered EMP voltage) to one or more event detection triggers 428. The one or more event discrimination filters 426 include a high-value resistor divider network that reduces the magnitude of the filter output voltage to the permissible input voltage range of a very-low-quiescent-current comparator. The event discrimination filters 426 include networks of resistors, diodes, and capacitors connected to the outputs of each dual-loop antenna 404. The individual filters discriminate between the different EMP event types. Event discrimination signal conditioning circuitry converts the high-voltage outputs of the individual event discrimination filters into lower voltage buffered signals. Resistor divider networks transform the high voltage signals into lower voltage signals. These lower voltage signals are then buffered by operational amplifiers. The buffered signals are measured by analog-to-digital converters. Each of the event discrimination filters 426 are located in the front-end circuitry of the EMP detection system includes a resistor in series with its high voltage storage capacitor. The values of the resistor and capacitor in each filter determine the response of that filter to EMP or high-power RADAR type events. The resistors may withstand high voltages and support high pulse-currents to allow rapid charging of the storage capacitor.

When one of the storage capacitors in the event discrimination filters 426 exceeds a threshold, the signal may be passed to the event detection triggers. In the event detection triggers 428, the open-drain outputs of the two comparators are tied together so that an event seen by any one of these comparators awakes the signal buffers, analog-to-digital converter, and microcontroller from low power sleep mode. The event detection triggers 428 taps into the outputs of the event discrimination filters 426. A high value resistor divider network reduces the magnitude of the filter output voltage to the permissible input voltage range of a very low quiescent current comparator. The open-drain outputs of the two comparators are tied together so that an event seen by any one of these comparators awakes the signal buffers, analog-to-digital converter, and microcontroller from low power sleep mode.

When the event detection triggers 428 are triggered by the detected signal, this may awaken an EMP detection manager 430, which may include a microcontroller to further analyze the signal and prepare alerts based on the EMP event. The EMP detection manager 430 does not become fully operational until several hundred microseconds after detection of an EMP event and so is not able to control the capture of the outputs of the event discrimination filters 426 by the analog-to-digital converters. The event detection triggers 428 ensure that the analog-to-digital converters sample the outputs of the event discrimination filters 426 at the moment the outputs of certain filters (e.g., the filters associated with a harmful HEMP event) are at their maximum value. That moment occurs at a moment on the order of 10 microseconds (μs) after the appearance of a harmful HEMP event. This circuit may operate continuously while consuming less than 20 microamps (μA) current. The EMP detection manager 430 retrieves the stored signal measurements from the six analog-to-digital circuits. The microcontroller distinguishes harmful EMP events from other non-harmful and/or EMP-like events, such as those corresponding to lightning strikes, high-power RADAR, and high-power broadcast transmissions. The field strength of each EMP event is calculated and stored in an “Event Record” that can be downloaded over the unit's serial interface. The EMP detection manager 430 will activate an alarm buzzer when a EMP event is detected. The alarm buzzer can be deactivated with a button press or once the EMP event data has been downloaded from the unit to an external PC.

FIG. 5 is a representation of an EMP detection system 524, according to at least one embodiment of the present disclosure. As discussed herein, a dual-loop antenna 504 may passively monitor for EMP events. Change in the electromagnetism around the dual-loop antenna 504 may cause a signal to be passed to one or more event discrimination filters 526. The event discrimination filters 526 may filter the incoming signal from the dual-loop antenna 504 and pass the filtered signal (e.g., the filtered EMP voltage) to one or more event detection triggers 528. The event detection triggers 528 may determine whether an EMP event has occurred, as discussed above with respect to FIG. 4.

If the event detection triggers 528 determine that an EMP event has occurred, then the event detection triggers 528 may cause a power wakeup circuit 532 to transition the EMP detection system 524 from a low-power mode to an analysis and transmission power mode (e.g., the event detection triggers 528 may initiate a power wakeup). Initiating a power wakeup may include starting or otherwise powering on a power wakeup circuit. For example, initiating a power wakeup may include closing one or more circuits to provide power from the power circuit to the circuitry. Initiating the power wakeup after the event detection triggers 528 determine that the EMP event has occurred may facilitate monitoring for the EMP event in the low power mode, without powering circuits that are not operating.

The analysis and transmission power mode may be a higher-power mode than the low-power mode. In accordance with at least one embodiment of the present disclosure, signal reception by the dual-loop antenna 504, filtering by the event discrimination filters 526, and triggering by the event detection triggers 528 may occur passively, or while the EMP detection system 524 is in the low-power mode.

The power wakeup circuit 532 may cause an EMP detection manager 530 to receive power from the power source. For example, the power wakeup circuit 532 may cause one or more switches or relays to transfer power to the EMP detection manager 530. This may cause the EMP detection manager 530 to transition from the low-power mode to the analysis and transmission mode. In the analysis and transmission mode, the EMP detection manager 530 may analyze the filtered signal (e.g., the filtered EMP voltage) from the dual-loop antenna 504 and the event discrimination filters 526. The EMP detection manager 530 may identify the type of the EMP event. After identifying the type of the EMP event, the EMP detection manager 530 may determine whether to record the EMP event and/or prepare an alert for the EMP event. For example, the EMP detection manager 530 may determine that the EMP event has a nuclear detonation as a source. Upon identifying that the EMP event is a harmful EMP event, the EMP detection manager 530 may send an alert or other instruction to nearby electronic devices and/or operators. This may allow the electronic devices to power down and/or otherwise be placed in shielding, thereby protecting the electronics from the EMP event. This may also alert operators of the need to alter their course of action, informed with the knowledge that local and distant electronics may have been damaged by the EMP event.

FIG. 6 is a representation of an EMP detection system 624, according to at least one embodiment of the present disclosure. As discussed herein, a dual-loop antenna 604 may passively monitor for EMP events. Change in the electromagnetism around the dual-loop antenna 604 may cause a signal to be passed to one or more event discrimination filters 626. The event discrimination filters 626 may filter the incoming signal from the dual-loop antenna 604 and pass the filtered signal (e.g., the filtered EMP voltage) to one or more event detection triggers 628. The event detection triggers 628 may determine whether an EMP event has occurred, as discussed above with respect to FIG. 4.

An EMP event type identifier 634 may receive the filtered signals from the dual-loop antenna 604, the one or more event discrimination filters 626, and the event detection triggers 628 and identify an event type of the EMP event. For example, the EMP event type identifier 634 may analyze the voltage signals. Based on the pattern of voltage signals, the EMP event type identifier 634 may identify a source of the EMP event. In some embodiments, based on the pattern of voltage signals, the EMP event type identifier 634 may identify a magnitude of the EMP event, a direction of the EMP event, an elevation of the EMP event, a distance of the EMP event, any other property of the EMP event, and combinations thereof.

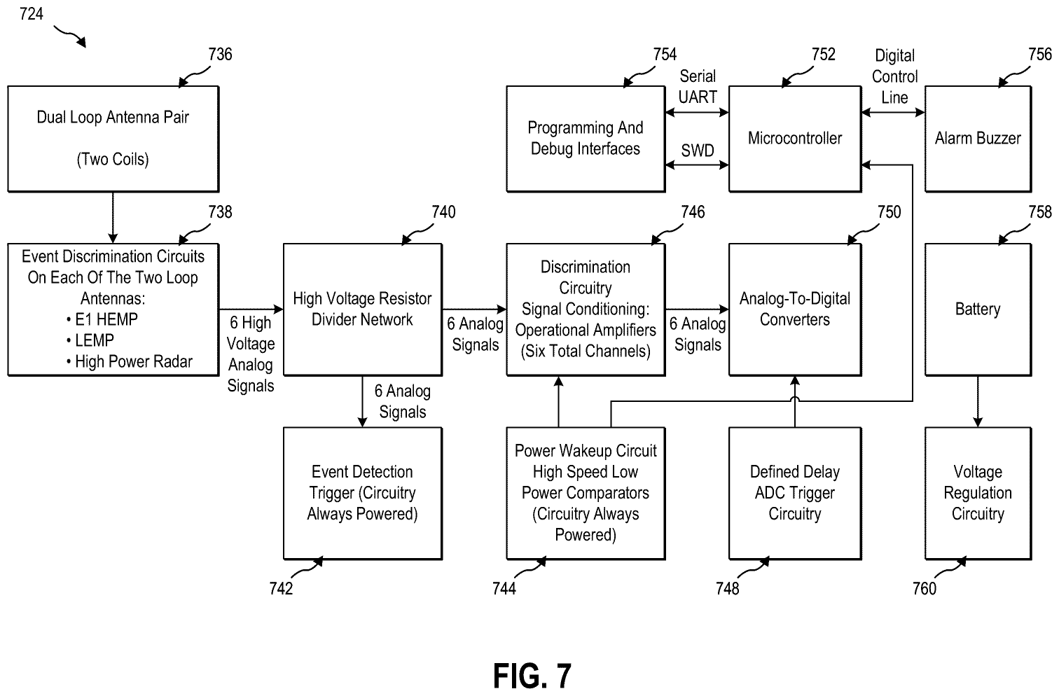

FIG. 7 is a flowchart of a control system for an EMP detection system 724, according to at least one embodiment of the present disclosure. It should be understood that FIG. 7 is exemplary, and that the techniques of the present disclosure may be applied to other specific implementations. The EMP detection system 724 may include a dual-loop antenna pair 736. The dual-loop antenna pair 736 may passively receive signals based on EMP events or other electromagnetic phenomena. Event discrimination circuits 738 may receive the signals from the dual-loop antenna pair 736 and filter the input signal into one or more analog signals. A high voltage resistor divider network 740. The high voltage resistor divider network 740 may divide the signals into a set of sub-signals.

A first set of sub-signals may be analyzed by an event detection trigger 742 may analyze the analog signals and determine whether to send the analog signal to a power wakeup circuit 744. The power wakeup circuit 744 may cause power to be provided to the EMP detection system 724, thereby causing the EMP detection system 724 to transition between the low-power state and an analysis and transition state.

Discrimination circuitry 746 may process the signal using operational amplifiers and other elements to process the signal. A defined delay analog to digital circuit 748 may convert generate an ADC signal, and analog to digital converters 750 may convert the signal to a digital signal. The digital signal may be transmitted to a microcontroller 752, in addition to an event wakeup control line. The microcontroller 752 may be in communication with programming and debug interfaces 754. Upon analysis of the signal, the microcontroller 752 may cause an alarm buzzer 756 to alarm.

The EMP detection system 724 includes a battery 758. The battery may power the EMP detection system 724. Voltage regulation circuitry 760 may regulate the power output of the battery 758 and assist and transitioning between the powered state and the unpowered state.

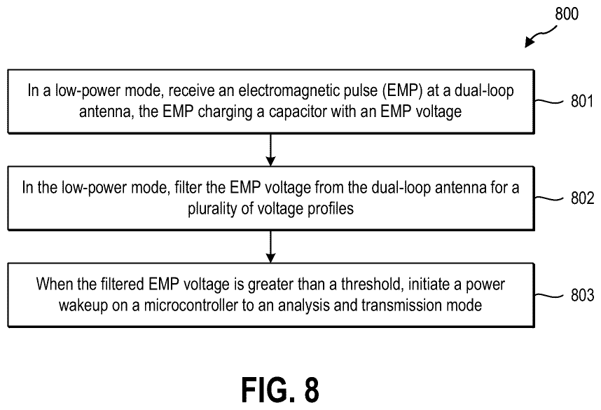

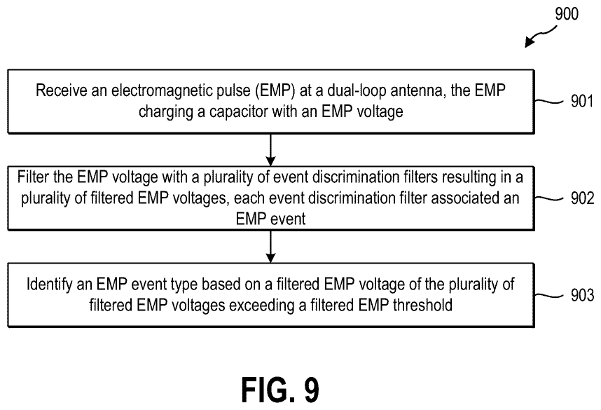

FIG. 8 and FIG. 9, the corresponding text, and the examples provide a number of different methods, systems, devices, and computer-readable media of the systems described herein. In addition to the foregoing, one or more embodiments can also be described in terms of flowcharts comprising acts for accomplishing a particular result, as shown in FIG. 8 and FIG. 9. FIG. 8 and FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 8 illustrates a flowchart of a series of acts or a method 800 for EMP detection, according to at least one embodiment of the present disclosure. While FIG. 8 illustrates acts according to one embodiment, alternative embodiments may omit, add to, reorder, and/or modify any of the acts shown in FIG. 8. The acts of FIG. 8 can be performed as part of a method. Alternatively, a computer-readable medium can comprise instructions that, when executed by one or more processors, cause a computing device to perform the acts of FIG. 8. In some embodiments, a system can perform the acts of FIG. 8.

A EMP detection system may, in a low-power mode, receive an EMP at a dual-loop antenna at 801. The EMP may charge a capacitor with an EMP voltage. In the low-power mode, the EMP detection system may filter the EMP voltage from the dual-loop antenna for a plurality of voltage profiles at 802. When the filtered EMP voltage is greater than a threshold, the EMP detection system may initiate a power wakeup on a microcontroller to an analysis and transmission mode at 803.

In some embodiments, while in the analysis and transmission mode, the EMP detection system may activate an alert by the microcontroller. In some embodiments, when the filtered EMP voltage is lower than a threshold, the EMP detection system may maintain the low-power mode. In some embodiments, receiving the EMP at the dual-loop antenna includes receiving the EMP at three dual-loop antennas arranged orthogonally.

As mentioned, FIG. 9 illustrates a flowchart of a series of acts or a method 900 for EMP detection, according to at least one embodiment of the present disclosure. While FIG. 9 illustrates acts according to one embodiment, alternative embodiments may omit, add to, reorder, and/or modify any of the acts shown in FIG. 9. The acts of FIG. 9 can be performed as part of a method. Alternatively, a computer-readable medium can comprise instructions that, when executed by one or more processors, cause a computing device to perform the acts of FIG. 9. In some embodiments, a system can perform the acts of FIG. 9.

In some embodiments, an EMP detection system may an EMP at a dual-loop antenna at 901. The EMP may charge a capacitor with an EMP voltage. The EMP detection system may filter the EMP voltage with a plurality of event discrimination filters resulting in a plurality of filtered EMP voltages at 902. Each event discrimination filter is associated with an EMP event. The EMP detection system may identify an EMP event type based on a filtered EMP voltage of the plurality of filtered EMP voltages exceeding a filtered EMP threshold at 903.

In some embodiments, the EMP detection system identifies the EMP event as a high-altitude EMP (HEMP) event. In some embodiments, the event detection system may generate an alert based on identifying the HEMP event. In some embodiments, generating the alert includes generating the alert less than 1 second after receiving the EMP at the dual-loop antenna. In some embodiments, the dual-loop antenna includes three dual-loop antennas arranged mutually orthogonally, and, based on a difference in the EMP voltage across the three dual-loop antennas, the EMP detection system may identify a direction of the HEMP event. In some embodiments, identifying the direction of the HEMP event includes identifying a location and an elevation of the HEMP event. In some embodiments, the EMP detection system identifies a magnitude of the HEMP event based on the EMP voltage at the capacitor.

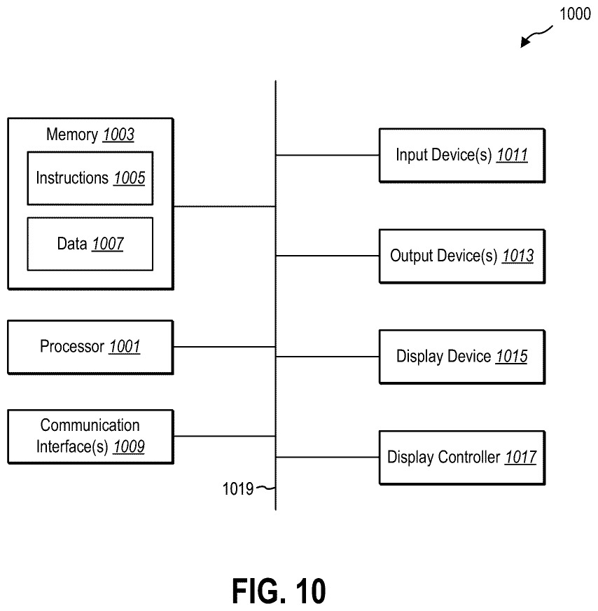

FIG. 10 illustrates certain components that may be included within a computer system 1000. One or more computer systems 1000 may be used to implement the various devices, components, and systems described herein.

The computer system 1000 includes a processor 1001. The processor 1001 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1001 may be referred to as a central processing unit (CPU). Although just a single processor 1001 is shown in the computer system 1000 of FIG. 10, in an alternative configuration, a combination of processors (e.g., an ARM and DSP) could be used.

The computer system 1000 also includes memory 1003 in electronic communication with the processor 1001. The memory 1003 may be any electronic component capable of storing electronic information. For example, the memory 1003 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1005 and data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during execution of the instructions 1005 by the processor 1001.

A computer system 1000 may also include one or more communication interfaces 1009 for communicating with other electronic devices. The communication interface(s) 1009 may be based on wired communication technology, wireless communication technology, or both. Some examples of communication interfaces 1009 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1000 may also include one or more input devices 1011 and one or more output devices 1013. Some examples of input devices 1011 include a keyboard, mouse, microphone, remote control device, button, joystick, trackball, touchpad, and lightpen. Some examples of output devices 1013 include a speaker and a printer. One specific type of output device that is typically included in a computer system 1000 is a display device 1015. Display devices 1015 used with embodiments disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For the sake of clarity, the various buses are illustrated in FIG. 10 as a bus system 1019.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A high-altitude electromagnetic pulse (HEMP) detection system, comprising:
a dual-loop antenna, including:
an antenna substrate having a first side and a second side opposite the first side;
a first loop antenna located on the first side of the antenna substrate, the first loop antenna having a first polarity; and
a second loop antenna located on the second side of the antenna substrate, the second loop antenna having a second polarity opposite the first polarity.

2. The HEMP detection system of claim 1, further comprising:
an event discrimination circuit including a capacitor, the capacitor receiving current applied to at least one of the first loop antenna or the second loop antenna;
an event detection trigger connected to the event discrimination circuit, the event detection trigger set to a threshold applied to the capacitor; and
a power source.

3. The HEMP detection system of claim 2, wherein the power source is not connected to the dual-loop antenna or the event discrimination circuit.

4. The HEMP detection system of claim 2, wherein the detection trigger operates in a low-power mode in which the HEMP detection system draws between 20 and 100 microamps (μA).

5. The HEMP detection system of claim 1, wherein the dual-loop antenna includes a plurality of dual-loop antennas.

6. The HEMP detection system of claim 5, wherein the dual-loop antenna includes a first dual-loop antenna, a second dual-loop antenna, and a third dual-loop antenna.

7. The HEMP detection system of claim 6, wherein the first dual-loop antenna, the second dual-loop antenna, and the third dual-loop antenna are mutually orthogonal.

8. The HEMP detection system of claim 1, further comprising a power source, wherein the power source is configured to transition between a low-power and an analysis and transmission mode.

9. A method performed by a high-altitude electromagnetic pulse (HEMP) detection system, the method comprising:
detecting, while operating in a low-power mode, an electromagnetic pulse (EMP) at a dual-loop antenna based on the EMP charging a capacitor with an EMP voltage;
filtering, while operating in the low-power mode, the EMP voltage from the dual-loop antenna for a plurality of voltage profiles; and
based on the filtered EMP voltage exceeding a threshold voltage, initiating a power wakeup on a microcontroller to initiate operation of the HEMP detection system in an analysis and transmission mode.

10. The method of claim 9, further comprising, while operating in the analysis and transmission mode, activating an alert by the microcontroller.

11. The method of claim 9, wherein receiving the EMP at the dual-loop antenna includes passively receiving the EMP at the dual-loop antenna when the dual-loop antenna is unpowered.

12. The method of claim 9, wherein, when the filtered EMP voltage is lower than the threshold voltage, maintaining the low-power mode.

13. The method of claim 9, wherein receiving the EMP at the dual-loop antenna includes receiving the EMP at three dual-loop antennas arranged mutually orthogonally.

14. A method performed by a high-altitude electromagnetic pulse (HEMP) detection system, the method comprising:
receiving an electromagnetic pulse (EMP) at a dual-loop antenna based on the EMP charging a capacitor with an EMP voltage;
filtering the EMP voltage with a plurality of event discrimination filters resulting in a plurality of filtered EMP voltages, each event discrimination filter associated with an EMP event; and
identifying an EMP event type based on a filtered EMP voltage of the plurality of filtered EMP voltages exceeding a filtered EMP threshold.

15. The method of claim 14, wherein identifying the EMP event type includes identifying a high-altitude EMP (HEMP) event.

16. The method of claim 15, further comprising, based on identifying the HEMP event, generating an alert.

17. The method of claim 16, wherein generating the alert includes generating the alert less than one second after receiving the EMP at the dual-loop antenna.

18. The method of claim 15, wherein the dual-loop antenna includes three dual-loop antennas arranged mutually orthogonally, and wherein the method further comprises identifying, based on a difference in the EMP voltage across the three dual-loop antennas, a direction of the HEMP event relative to dual-loop antenna.

19. The method of 18, wherein identifying the direction of the HEMP event includes identifying a location and an elevation of the HEMP event.

20. The method of claim 15, further comprising identifying a magnitude of the HEMP event based on the EMP voltage at the capacitor.
